(19) United States
(12) Patent Application Publication
(10) Pub. No.: US 2013/0240044 A1
(43) Pub. Date: Sep. 19, 2013

(54) METHOD AND APPARATUS FOR CONTROL OF MASS COMPOSITION OF MOBILE PHASE

(71) Applicants: Joshua A. Shreve, Franklin, MA (US); Peter Kirby, Derry, NH (US)

(72) Inventors: Joshua A. Shreve, Franklin, MA (US); Peter Kirby, Derry, NH (US)

(73) Assignee: WATERS TECHNOLOGY CORPORATION, Milford, MA (US)

(21) Appl. No.: 13/989,180

(22) PCT Filed: Nov. 28, 2011
(86) PCT No.: PCT/US11/62228

§ 371 Date: May 23, 2013

Related U.S. Application Data
(60) Provisional application No. 61/421,392, filed on Dec. 9, 2010.

(51) Int. Cl. G01N 30/04

(52) U.S. Cl. CPC G01N 30/04
USPC 137/3; 137/468

(57) ABSTRACT

Described are a method and an apparatus for delivering a fluid having a desired mass composition. According to the method, temperatures of the fluids to be mixed are sensed and the densities of the fluids at the sensed temperatures are determined. The volume of each fluid is determined so that a mixture of the fluids at the sensed temperatures has the desired mass composition. The determined volumes of the fluids are combined to create the mixture. In one option, combining the determined volumes includes metering flows of the fluids sequentially into a common fluid channel. Alternatively, combining the determined volumes includes controlling a flow rate of each of the fluids and directing the fluids into a common fluid channel.

### RELATED APPLICATION

This application claims the benefit of the earlier filing date of U.S. Provisional Patent Application Ser. No. 61/421,392, filed Dec. 9, 2010 and titled “Method and Apparatus for Control of Mass Composition of Mobile Phase,” the entirety of which is incorporated herein by reference.

### FIELD OF THE INVENTION

The invention relates generally to a method and apparatus for delivering a fluid having a desired mass composition. More particularly, the invention relates to a method to reduce or eliminate compositional error due to temperature-dependent density changes of solvents in a mobile phase in a liquid chromatography system.

### BACKGROUND

Chromatography is a set of techniques for separating a mixture into its constituents. For instance, in a liquid chromatography application, a pump takes in and delivers a mixture of liquid solvents to a sample manager, where an injected sample awaits its arrival. In an isocratic chromatography application, the composition of the liquid solvents remains unchanged, whereas in a gradient chromatography application, the solvent composition varies over time. The mobile phase, comprised of a sample dissolved in a mixture of solvents, passes through a column of particulate matter, referred to as the stationary phase. By passing the mixture through the column, the various components in the sample separate from each other at different rates and thus elute from the column at different times. A detector receives the elution from the column and produces an output from which the identity and quantity of the analytes may be determined.

Conventional pumps used for liquid chromatography meter solvents according to volume. The behavior of a liquid chromatography system is affected by the number of moles of the solvent that are delivered in a given volume. The molar density of the solvent is proportional to the solvent mass density. Generally, a solvent has a mass density that is dependent on the solvent temperature thus changes in temperature generally affect retention times. Consequently, chromatography measurement data can be adversely affected by temperature variations even though the volumes of the solvents are accurately metered.

Liquid chromatography systems are sometimes deployed in environments where the temperature is not accurately controlled. Under such circumstances, mass composition variation in the solvent can occur, resulting in a loss of measurement accuracy and repeatability. In some system environments the temperature is well controlled; however, variation in temperature for different instrument locations generally results in variations in measurement data obtained from the instruments.

The present invention addresses a need to maintain a desired mass composition of a mobile phase solvent regardless of the ambient temperature and temperature changes.

### SUMMARY

In one aspect, the invention features a method for delivering a fluid having a desired mass composition. For a plurality of fluids to be mixed to have a desired mass composition at a reference temperature, a temperature of each of the fluids is sensed and a density of each fluid at the respective sensed temperature is determined. A volume of each fluid is determined so that a mixture of the fluids at the sensed temperatures has the desired mass composition and the determined volumes of the fluids are combined.

In another aspect, the invention features an apparatus for delivering a fluid having a predetermined mass composition. The apparatus includes a metering device having a plurality of inlet ports and an outlet port. Each inlet port is configured to receive a fluid from a plurality of fluids to be mixed. The outlet port delivers a mixture of the fluids having a predetermined mass composition at a reference temperature. The mixture includes a volume of each of the fluids. The apparatus also includes a temperature sensor, a memory module and a processor. The temperature sensor is in thermal communication with the metering device and the memory module is configured to store temperature-dependent density data for each of the fluids. The processor is in communication with the metering device and the temperature sensor. The processor is configured to receive a signal from the temperature sensor and to determine a density of each of the fluids. The processor generates a signal to control the volumes of the fluids in the mixture delivered from the metering device based on the determined densities of each of the fluids to thereby maintain the predetermined mass composition.

In still another aspect, the invention features an apparatus for delivering a fluid having a desired mass composition. The apparatus includes fluid sources, temperature sensors, a combiner, a memory module and a processor. Each fluid source is configured to supply a fluid to be mixed with fluids from the other fluid sources to form a mixture of fluids having a desired mass composition at a reference temperature. Each temperature sensor is in thermal communication with a respective one of the fluid sources. The combiner has a plurality of input ports each in fluidic communication with one of the fluid sources. The combiner also has an output port to deliver the mixture of fluids. The memory module is configured to store temperature-dependent density data for each of the fluids. The processor is in communication with the fluid sources and the temperature sensors. The processor is configured to receive a signal from each of the temperature sensors and to determine a density of each of the fluids. The processor generates at least one signal to control the flow rates of the fluids supplied by the fluid sources to the combiner based on the determined density of each of the fluids to thereby maintain the desired mass composition of the mixture of fluids.

### BRIEF DESCRIPTION OF THE DRAWINGS

The above and further advantages of this invention may be better understood by referring to the following description in conjunction with the accompanying drawings, in which like numerals indicate like structural elements and features in the various figures. For clarity, not every element may be labeled in every figure. The drawings are not necessarily to scale, emphasis instead being placed upon illustrating the principles of the invention.

FIG. 1 is an illustration of an embodiment of a liquid chromatography system according to the invention.

FIG. 2 is a flowchart representation of an embodiment of a method for delivering a fluid having a temperature-independent mass composition according to the invention.

FIG. 3 is a graphical illustration showing an example of how volume contributions for a two-solvent mixture change with a temperature change according to the method of FIG. 2.

FIG. 4 is a graphical illustration showing an example of how the volume contributions for a three-solvent mixture change with a temperature change according to the method of FIG. 2.

FIG. 5 is an illustration of another embodiment of a liquid chromatography system according to the invention.

FIG. 6 is a flowchart representation of another embodiment of a method for delivering a fluid having a temperature-independent mass composition according to the invention.

### DETAILED DESCRIPTION

Reference in the specification to “one embodiment” or “an embodiment” means that a particular, feature, structure or characteristic described in connection with the embodiment is included in at least one embodiment of the teaching. References to a particular embodiment within the specification do not necessarily all refer to the same embodiment.

The present teaching will now be described in more detail with reference to exemplary embodiments thereof as shown in the accompanying drawings. While the present teaching is described in conjunction with various embodiments and examples, it is not intended that the present teaching be limited to such embodiments. On the contrary, the present teaching encompasses various alternatives, modifications and equivalents, as will be appreciated by those of skill in the art. For example, various embodiments described herein refer to solvents although it should be recognized that other fluids or liquids can be used. Those of ordinary skill having access to the teaching herein will recognize additional implementations, modifications and embodiments, as well as other fields of use, which are within the scope of the present disclosure as described herein.

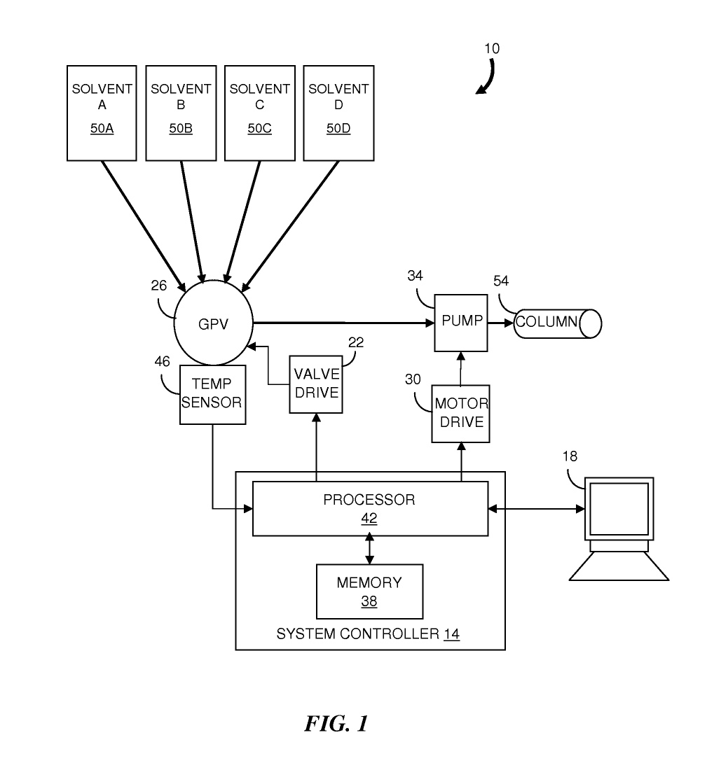

Referring to FIG. 1, an embodiment of a liquid chromatography system 10 according to the invention includes a system controller 14 that communicates with a user interface module 18 that receives input data and displays system information. The system controller 14 also communicates with a valve drive module 22 for operating a gradient proportioning valve (GPV) 26 and a motor drive module 30 for operating one or more stepper motors for a pump system 34. In one embodiment, the pump system 34 includes complementary pump heads that are operated in a synchronized manner as is known in the art. The system controller 14 further includes a memory module 38 and a processor 42. The processor 42 is configured to read data from and write data to the memory module 38. For example, the processor 42 can receive input data from the user interface 18, measurement data from analytical detectors (not shown) and data from various control components and system sensors (e.g., temperature sensor 46).

The gradient proportioning valve 26 includes a plurality of fluid switching valves that are connected by tubing or fluid channels to respective component reservoirs 50A, 50B, 50C and 50D. The reservoirs 50 contain the solvents to be combined, or “mixed”, with each other. The outlet port of the gradient proportioning valve 26 is coupled to the inlet port of the pump system 34. The solvent mixture is delivered from the pump outlet port to a chromatographic column 54, typically at a substantially higher pressure than the pressure of the solvent mixture exiting the gradient proportioning valve 26.

During operation of the liquid chromatography system 10, the switching valves of the gradient proportioning valve 26 are opened sequentially during a metering cycle so that the pump system 34 draws a volume of fluid from each of the reservoirs 50. The proportions of solvents present in the fluid mixture depend on the actuation times for each of the switching valves in relation to the inlet velocity profile during the intake cycle. Thus the mass composition of the fluid mixture is also determined by the actuation times.

The mass density of a fluid at a given pressure is dependent on the fluid temperature. For example, if the temperature of a solvent increases, the mass of the solvent delivered in a fixed volume of solvent typically decreases. Moreover, the change in the mass density of a solvent for a given temperature change is different for different solvents. Thus, if the temperature of the solvents change, the mass composition (or molar composition) of the solvent mixture delivered to the pump system 34 also changes. In conventional liquid chromatography systems, a desired mass composition is only achieved if the solvents can be maintained at a desired temperature (i.e., a “reference temperature”).

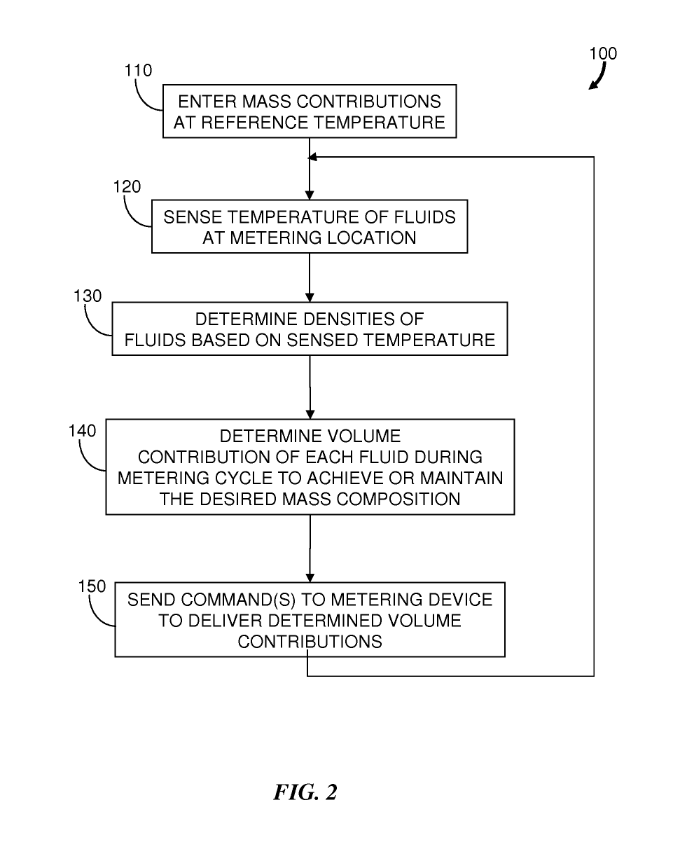

FIG. 2 is a flowchart representation of an embodiment of a method 100 for delivering a fluid having a desired mass composition that is independent of temperature and temperature change. Initially, the chromatography system 10 of FIG. 1 is configured for operation according to a predetermined ratio or gradient. For example, an operator provides data (step 110) to the system controller 14 through the user interface 18 to indicate the solvents to be mixed and their mass contributions at a reference temperature. The mass contribution of each solvent corresponds to a volume contribution for each metering cycle of the gradient proportioning valve (i.e., a “GPV metering cycle”). During a chromatography measurement run, the temperature of the solvents to be mixed is sensed (step 120) by the temperature sensor 46 at the gradient proportioning valve 26. Thus the temperature is sensed at the location where the solvents are metered into a common flow.

The density of each solvent is determined (step 130) according to the sensed temperature. In a preferred embodiment, the solvent densities at the sensed temperature are determined from a lookup table stored in the memory module 38. The lookup table should include a sufficient number of data points for each solvent to accurately represent the functional relationships of the solvent densities with respect to temperature for the full operational temperature range of the liquid chromatography system 10. The resolution of the temperature measurements should be sufficient to limit any mass composition error. For example, a thermistor having a ±0.2° C. accuracy is an adequate sensor 46 for many chromatography applications. In an alternative embodiment, the solvent densities are determined by calculating real-time using stored parameters that describe the functional relationship of the solvent density with respect to temperature. This alternative embodiment can be less efficient than using a lookup table, especially if the changes in solvent densities are substantially nonlinear over the operational temperature range.

A desired volume contribution for each solvent during a GPV metering cycle is determined (step 140) based on the solvent densities at the sensed temperature so that the mass composition of the solvent mixture is the same as the mass composition for the reference temperature. The system controller 14 sends commands (step 150) to the valve drive 22 so that the gradient proportioning valve 26 delivers the mixture of the solvents with the desired mass composition to the pump system 34.

In some embodiments, the mass composition at the reference temperature is desired to change in a predetermined manner in time. For example, the mass composition may be defined as a gradient such that the mass density of at least one of the solvents increases or decreased in a desired manner relative to the mass density of at least one of the other solvents in the mixture over time. In these embodiments, step 110 corresponds to entry of the desired composition ramp and therefore step 140 includes determining the volume contributions for the desired mass composition at the current ramp time.

In most chromatographic applications, the temperatures vary slowly in time. Consequently, the method 100 can be iterated at a slow rate, for example, by repeating steps 120 through 150 at a rate of once per second or less.

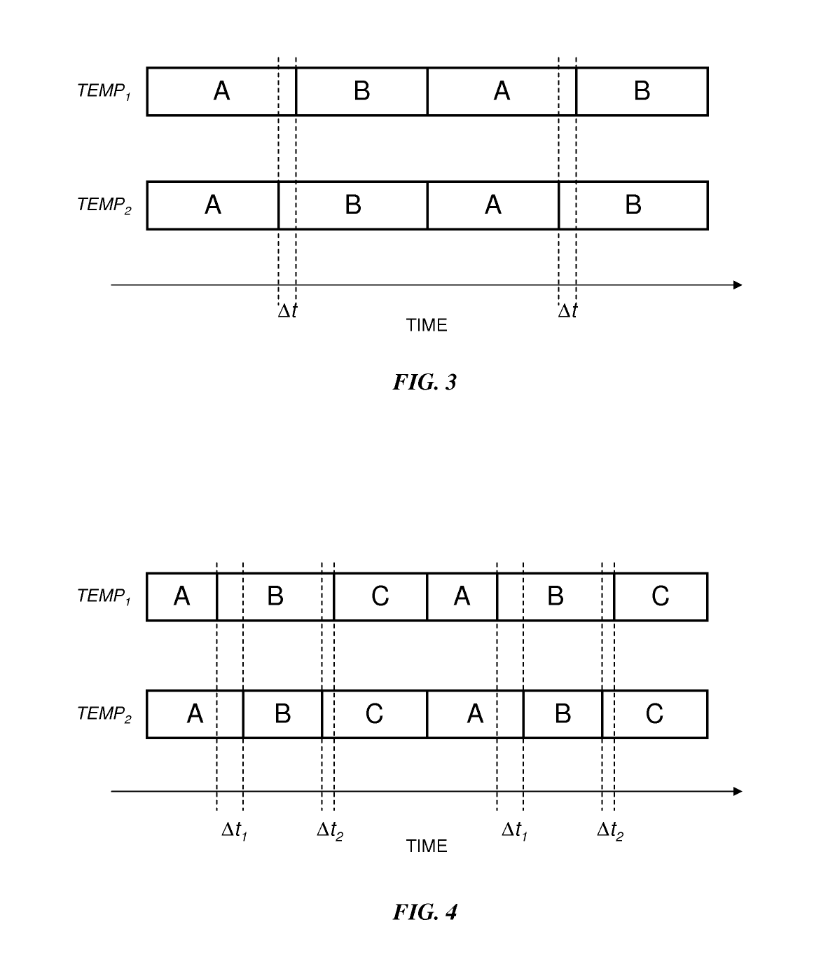

FIG. 3 is a graphical depiction of an example of how the volume contributions for a two-solvent mixture change with a temperature change according to the method 100. Each block represents the GPV actuation time (or volume contribution) for two solvents A and B. The upper row and lower row of blocks depict two full cycles of operation of a gradient proportioning valve at a first temperature TEMP₁ and a second temperature TEMP₂, respectively. In the illustrated example, the second temperature is greater than the first temperature. In addition, the relative decrease in the density of solvent A is less than the relative decrease in the density of solvent B. Consequently, the volume contribution of solvent A is reduced and the volume contribution of solvent B is increased during a GPV metering cycle to achieve the same mass composition of the mixture for the first temperature. As volume is determined by motor steps which is proportional to actuation time (during the constant velocity portion of intake), the actuation time of solvent A during a single GPV cycle is reduced by a time Δt and the actuation time of solvent B is increased by the same time Δt. Thus the total volume delivered during a GPV metering cycle remains unchanged.

FIG. 4 is a graphical depiction showing an example of how the volume contributions for a three-solvent mixture change according to the method 100. Again, the second temperature TEMP₂ is greater than the first temperature TEMP₁. In this example, the relative decrease in the density of solvent B is less than the relative decrease in the density of solvent C, and the relative decrease in the density of solvent C is less than the relative decrease in the density of solvent A. Consequently, the volume contributions and actuation times of the solvents are adjusted as shown in the lower row such that the solvent mixture at the second temperature has the same mass composition as the solvent mixture at the first temperature while the total volume delivered during a GPV metering cycle remains unchanged. In particular, the actuation time of solvent A is increased by a time Δt₁, the actuation time of solvent C is increased by a time Δt₂ and the actuation time of solvent B is decreased by a time Δt₁+Δt₂.

FIG. 4 shows an example in which two of the solvents have their volume contributions increased; however, in other instances only one of the solvents may require an increased volume contribution while the other two solvents have decreased volume contributions. Moreover, the method 100 can be applied to a mixture comprising any number of solvents.

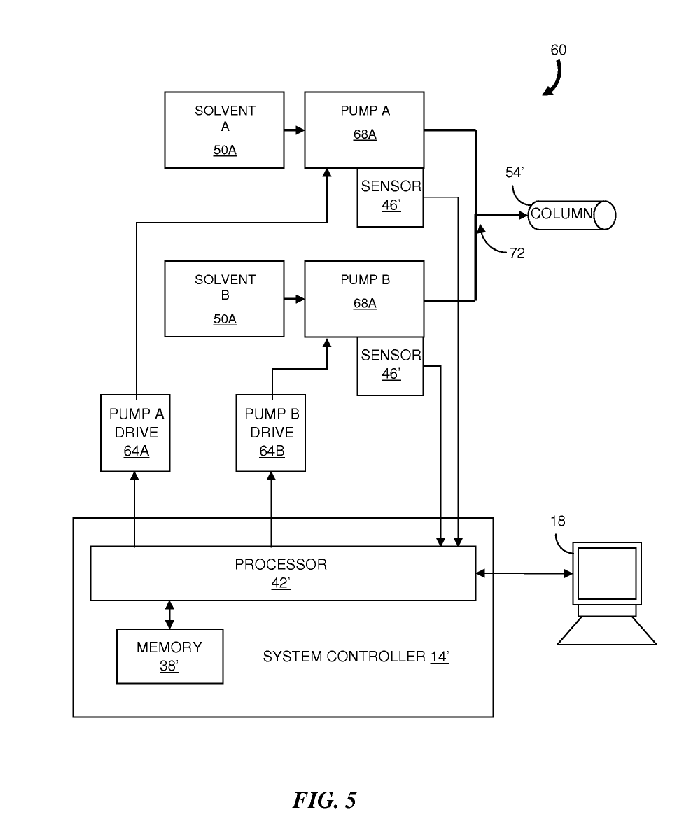

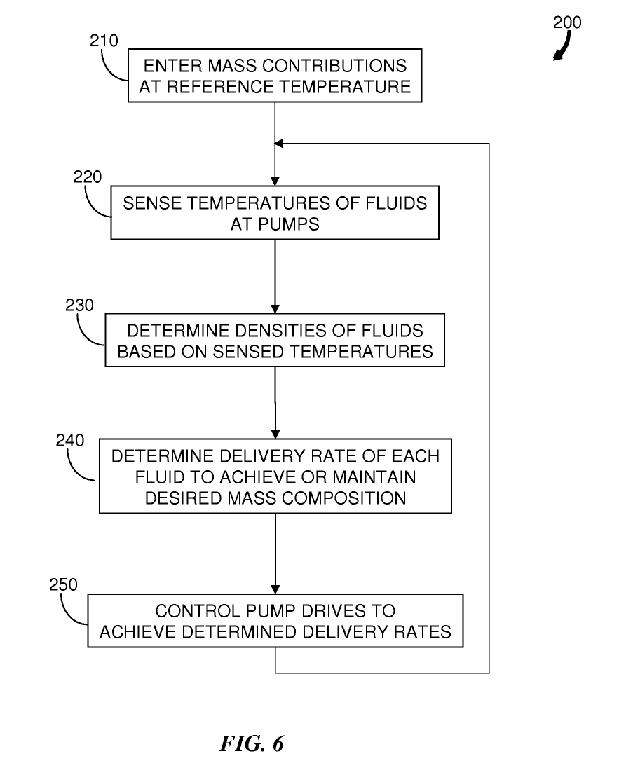

FIG. 5 shows another embodiment of a liquid chromatography system 60 according to the invention. The system controller 14′ communicates with a pair of pump drives 64A and 64B for operating a pair of solvent pumps 68A and 68B. The solvents are mixed at a tee-coupling 72. FIG. 6 is a flowchart representation of an embodiment of a method 200 for delivering a fluid having a desired mass composition that can be used with the system 60 of FIG. 5. Initially, the chromatography system 60 is configured (step 210) to operate according to a predetermined ratio or gradient, for example, by specifying the solvents to be mixed and their mass contributions at a reference temperature. During the chromatography measurement, the temperature of each solvent is sensed (step 220) by a temperature sensor 46′ at each pump head 68. In contrast to the system 10 of FIG. 1 in which a single temperature is sensed at a point where the volumes of the solvents are metered, the temperatures of the solvents used in the system 60 are determined where the solvent flow rates are controlled.

The density of each fluid is determined (step 230) according to the temperature sensed at the respective pump 68. Preferably, the densities at the sensed temperatures are determined from lookup tables stored in the memory module 38. Alternatively, the densities can be calculated using stored parameters that relate the density of each fluid to temperature.

A delivery rate, or flow rate, for each solvent is determined (step 240) so that the mass composition of the solvent mixture is the same as the mass composition at the reference temperature. The system controller 14 sends commands or control signals (step 250) to the pump drives 64 so that the pumps 68 adjust or maintain the flow rates of the solvents so that the solvent mixture has the same mass composition as the mixture at the reference temperature. Thus, as the flow rate of one solvent is increased, the flow rate of the other solvent is decreased accordingly so that the total volume of the solvents received at the column 54′ from the pair of pumps 68 remains constant.

While the invention has been shown and described with reference to specific embodiments, it should be understood by those skilled in the art that various changes in form and detail may be made therein without departing from the spirit and scope of the invention as recited in the accompanying claims.

What is claimed is:

1. A method for delivering a fluid having a desired mass composition, the method comprising:
for each fluid in a plurality of fluids to be mixed to have a desired mass composition at a reference temperature:
sensing a temperature of the fluid; and
determining a density of the fluid at the sensed temperature;
determining a volume of each of the fluids so that a mixture of the fluids at the sensed temperatures has the desired mass composition; and
combining the determined volumes of the fluids.

2. The method of claim 1 wherein a volumetric composition of the mixture of the fluids at the sensed temperatures is equal to a volumetric composition of a mixture of the fluids at the reference temperature.

3. The method of claim 1 wherein combining the determined volumes of the fluids comprises metering flows of the fluids sequentially into a common fluid channel.

4. The method of claim 3 wherein sensing the temperatures of the fluids comprises sensing a single temperature proximate to a location where the determined volumes are metered.

5. The method of claim 1 wherein combining the determined volumes of the fluids comprises controlling a flow rate of each of the fluids and directing the fluids into a common fluid channel.

6. The method of claim 5 wherein sensing the temperatures of the fluids comprises sensing a temperature of each of the fluids proximate to a location where the flow rate of the respective fluid is controlled.

7. The method of claim 1 wherein the fluids comprise solvents in a liquid chromatography system.

8. The method of claim 1 wherein combining the determined volumes comprises providing a fluid flow having the desired mass composition.

9. The method of claim 1 wherein the desired mass composition is predefined to vary in time.

10. The method of claim 9 wherein a volumetric flow of each of the fluids is determined so that a mixture of the fluids at the sensed temperatures has the predefined variations in the desired mass composition for a range of times.

11. An apparatus for delivering a fluid having a predetermined mass composition, comprising:
a metering device having a plurality of inlet ports each configured to receive a fluid from a plurality of fluids to be mixed and having an outlet port to deliver a mixture of the fluids having a predetermined mass composition at a reference temperature, the mixture comprising a volume of each of the fluids;
a temperature sensor in thermal communication with the metering device;
a memory module configured to store temperature-dependent density data for each of the fluids; and
a processor in communication with the metering device and the temperature sensor, the processor configured to receive a signal from the temperature sensor and to determine a density of each of the fluids, the processor generating a signal to control the volumes of the fluids in the mixture delivered from the metering device based on the determined densities of each of the fluids to thereby maintain the predetermined mass composition.

12. The apparatus of claim 11 wherein the metering device comprises a gradient proportioning valve.

13. The apparatus of claim 11 wherein the fluids comprise solvents in a liquid chromatography system.

14. The apparatus of claim 11 wherein a volume of the mixture delivered from the metering device is constant in time.

15. An apparatus for delivering a fluid having a desired mass composition, comprising:
a plurality of fluid sources each configured to supply a fluid to be mixed with the fluids from the other fluid sources to form a mixture of fluids having a desired mass composition at a reference temperature;
a plurality of temperature sensors each in thermal communication with a respective one of the fluid sources;
a combiner having a plurality of input ports each in fluidic communication with one of the fluid sources, the combiner having an output port to deliver the mixture of fluids;
a memory module configured to store temperature-dependent density data for each of the fluids; and
a processor in communication with the fluid sources and the temperature sensors, the processor configured to receive a signal from each of the temperature sensors and to determine a density of each of the fluids, the processor generating at least one signal to control the flow rates of the fluids supplied by the fluid sources to the combiner based on the determined density of each of the fluids to thereby maintain the desired mass composition of the mixture of fluids.

16. The apparatus of claim 15 wherein each of the fluid sources comprises a pump that is controlled by a signal generated by the processor.

17. The apparatus of claim 15 wherein the combiner comprises a tee-coupling.

18. The apparatus of claim 15 wherein the fluids comprise solvents in a liquid chromatography system.

19. The apparatus of claim 15 wherein a flow rate of the mixture of fluids delivered from the combiner is constant in time.
